(19) United States
(12) Patent Application Publication
(10) Pub. No.: US 2006/0025205 A1
(43) Pub. Date: Feb. 2, 2006

(54) Gaming machine having a wagering game including player-selectable elements that mask unknown types and numbers of various awards

(76) Inventors: Michael P. Casey, Chicago, IL (US); Jason C. Gilmore, Scottsdale, AZ (US); Bradley A. Rose, Chicago, IL (US)

Correspondence Address: Daniel J. Burnham;JENKENS & GILCHRIST, A PROFESSIONAL CORPORATION, Ste. 2600, 225 W. Washington, Chicago, IL, 60606-3418, US

(21) Appl. No.: 11/192,255

(22) Filed: Jul. 28, 2005

Related U.S. Application Data
(60) Provisional application No. 60/591,690, filed on Jul. 28, 2004.

(51) Int. Cl. A63F 13/00

(52) U.S. Cl. 463/20

(57) ABSTRACT

A gaming machine is provided for playing a wagering game. The gaming machine includes a wager-input device and at least one display for displaying a plurality of player-selectable elements that mask corresponding ones of a plurality of awards. The plurality of awards include multiple types of the plurality of awards. Each one of the plurality of awards of the same type has a predetermined value that is different from a value of a different one of the types of the plurality of awards. At least one player-selectable element masks at least two different types of awards. An input device receives player-inputs that select at least two of the plurality of player-selectable elements. A number and a type of the masked awards corresponding with the selected player-selectable elements are revealed to the player in response to receiving the player inputs.

### PRIORITY

This application claims the benefit of priority under 35 U.S.C. §119 of provisional application Ser. No. 60/591,690, filed Jul. 28, 2004, the contents of which are hereby incorporated by reference in their entirety as if fully set forth.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to gaming machines, and methods for playing wagering games, and more particularly, to a gaming machine for implementing a wagering game where player-selectable elements are displayed that mask unknown types and numbers of various awards.

### BACKGROUND OF THE INVENTION

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and tile expectation of winning each machine is roughly the same (or believed to be the same), players are most likely to be attracted to the most entertaining and exciting of the machines. Shrewd operators consequently strive to employ the most entertaining and exciting, machines available because such machines attract frequent play and hence increase profitability to the operator. Accordingly, in the competitive gaming industry, there is a continuing need for slot machine manufacturers to produce new types of games, or enhancements to existing games, which will attract frequent play by enhancing the entertainment value and excitement associated with the game.

One concept that has been successfully employed to enhance the entertainment value of a game is the concept of a “secondary” or “bonus” game that may be played in conjunction with a “basic” game. The bonus game may comprise any type of game, either similar to or completely different from the basic game, which is entered upon the occurrence of a selected event or outcome in the basic game. Generally, bonus games provide a greater expectation of winning than the basic game and may also be accompanied with more attractive or unusual video displays and/or audio. Bonus games may additionally award players with “progressive jackpot” awards that are funded, at least in part, by a percentage of coin-in from the gaming machine or a plurality of participating gaming machines. Because the bonus game concept offers tremendous advantages in player appeal and excitement relative to other known games, and because such games are attractive to both players and operators, there is a continuing need to develop gaming machines with new types of bonus games to satisfy the demands of players and operators.

There are slot wagering games in the art that allow the player to select one of a plurality of objects during a bonus game. Based on the object selected, the player can receive different amounts of various awards. Each of the awards can provide a different credit value to the player. However, such wagering games only allow the player to select one of the plurality of objects. Accordingly, some players may believe that the bonus game is not long enough and may seek out other gaming machines.

Wagering games need to include additional features that will maintain the player's interest and enhance entertainment. The present invention is directed to satisfying this and other needs.

### SUMMARY OF THE INVENTION

According to one aspect of the present invention, a gaming machine is provided for playing a wagering game. The gaming machine includes a wager-input device and at least one display for displaying a plurality of player-selectable elements that mask corresponding ones of a plurality of awards. The plurality of awards include multiple types of the plurality of awards. Each one of the plurality of awards of the same type has a predetermined value that is different from a value of a different one of the types of the plurality of awards. At least one player-selectable element masks at least two different types of awards. An input device receives player-inputs that select at least two of the plurality of player-selectable elements. A number and a type of the masked awards corresponding with the selected player-selectable elements are revealed to the player in response to receiving the player inputs.

According to another aspect of the invention, a method of conducting a wagering game includes displaying a plurality of player-selectable elements that mask corresponding ones of a plurality of awards. The plurality of awards include multiple types of the plurality of awards. Each one of the plurality of awards of the same type has a predetermined value that is different from a value of a different one of the types of the plurality of awards. Player-inputs associated with the selection of the plurality of player-selectable elements are received. A first group of the masked awards corresponding to the first element of the plurality of the plurality of player-selectable elements are revealed and awarded in response to the selection of a first element of the plurality of the plurality of player-selectable elements. A second group of the masked awards corresponding to the second element of the plurality of the plurality of player-selectable elements is revealed and awarded in response to the selection of a second element of the plurality of the plurality of player-selectable elements. The first and second groups include awards of different types.

According to yet another aspect of the invention, a computer readable storage medium is encoded with instructions for directing a gaming device to perform the method described above.

An additional aspect of the invention is directed to a gaming system for playing a wagering game. The gaming system includes at least one display. A controller is coupled to the display and is programmed to display a plurality of player-selectable elements that mask corresponding ones of a plurality of awards. The plurality of awards includes multiple types of the plurality of awards. Each one of the plurality of awards of the same type has a predetermined value that is different from a value of a different one of the types of the plurality of awards. Player-inputs associated with the selection of the plurality of player-selectable elements are received. A first group of the masked awards corresponding to the first element of the plurality of the plurality of player-selectable elements are revealed and awarded in response to the selection of a first element of the plurality of the plurality of player-selectable elements. A second group of the masked awards corresponding to the second element of the plurality of the plurality of player-selectable elements are revealed and awarded in response to the selection of a second element of the plurality of the plurality of player-selectable elements. The first and second groups include awards of different types.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a gaming machine embodying the present invention;

FIG. 2 is a block diagram of a control system suitable for operating the gaming machine;

FIG. 3 illustrates a video slot game for triggering the “Alien Bonus” according to an embodiment of the invention; and

FIGS. 4-11 illustrate various screens displayed during the “Alien Bonus” game according to an embodiment of the invention.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

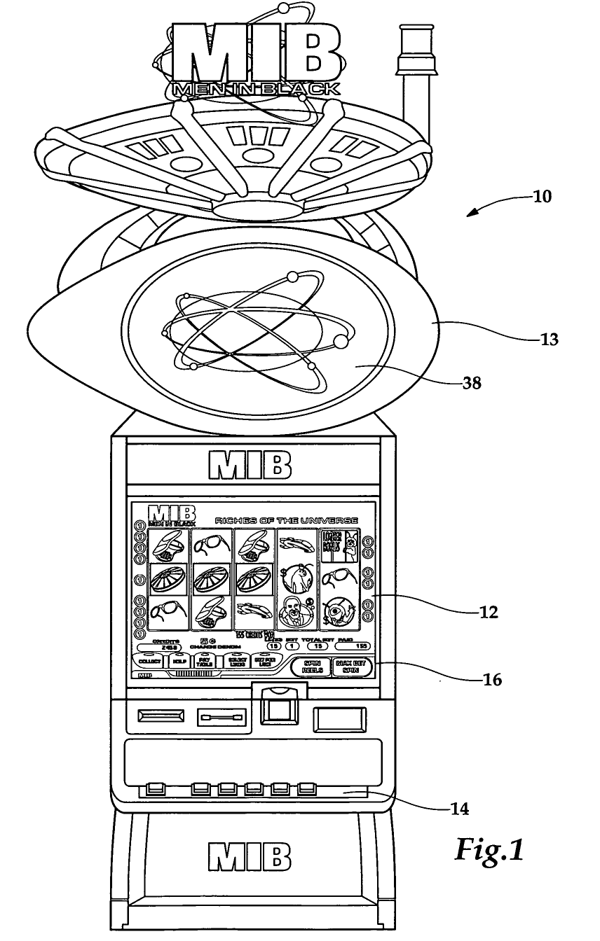

Turning now to the drawings and referring initially to FIG. 1, there is shown a gaming machine 10 for conducting a wagering game in accordance with the present invention. The gaming machine 10 comprises a primary display 12 that may, for example, be a mechanical reel slot display or a video display. If implemented in video, the primary display 12 may comprise a cathode ray tube (CRT), liquid crystal display (LCD), plasma, or generally any other type of video display known in the art. In the illustrated embodiment, the, gaming machine 10 is an “upright” version in which the primary display 12 is oriented vertically relative to the player. It will be appreciated, however, that any of several other models of gaming machines are within the scope of the present invention including, for example, a “slant-top” version in which the primary display 12 is slanted at about a thirty-degree angle toward the player. The gaming machine may include a secondary display 38 in top box 13, depending upon the design of the wagering game.

The gaming machine 10 includes a button panel 14 and an optional touch screen 16 for enabling a player to conduct the wagering game. The button panel 14 and the touch screen 16 may have some corresponding buttons for performing the same functions and other buttons for performing different functions. By way of example, a “$” button may be pressed to insert money to increase a player's credits. A “Change Denom” button may be touched to change denomination. A “Collect” button may be touched to Collect winnings. A “Pay Table” button may be touched to see the game's pay table. A “Select Lines” button may be touched to change the number of pay lines bet. A “Bet Per Line” button may be touched to change the amount of credits bet on each line. The number of lines to play is generally selected prior to selecting the amount to bet per line. A “Spin Reels” button may be touched to begin the game. A “Stop Reels” button may be touched to stop the reels while they are spinning. If the player does not touch the “Stop Reels” button, the reels will stop on their own. A “Max Bet Spin” button may be touched to play the maximum credits instantly.

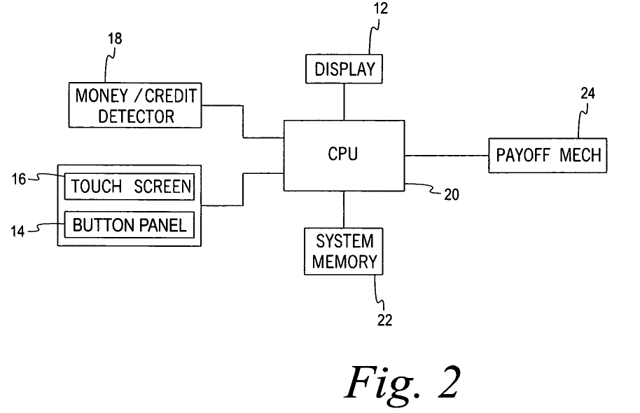

FIG. 2 is a block diagram of a control system suitable for operating the gaming machine. Money/credit detector 18 signals a central processing unit (CPU) 20 when a player has inserted money or played a number of credits. The money may be provided by coins, bills, tickets, coupons, cards, etc. Using the button panel 14 or touch screen 16, the player may select any game variables (e.g., number of pay lines in a reel slot game if more than one can be selected) and place his/her wager to play the wagering game. In a play of the game, the CPU 20 generates at least one random event using a random number generator (RNG) and provides an award to the player for a winning outcome of the random event. Alternatively, the random event may be generated by a remote computer using an RNG or pooling schema and then transmitted to the gaming machine. The CPU 20 operates the primary display 12 to represent the random event(s) and outcome(s) in a visual form that can be understood by the player. In addition to the CPU 20, the control system may include one or more additional slave control units for operating one or more Peripherals. The terms “processor” and “CPU” as used herein are each intended to collectively cover the CPU 20 and any and all such control units.

A system memory 22 stores control software, operational instructions and data associated with the gaming machine. In one embodiment, the system memory 22 comprises a separate read-only memory (ROM) and battery-backed random-access memory (RAM). However, it will be appreciated that the system memory 22 may be implemented on any of several alternative types of memory structures or may be implemented on a single memory structure. A payoff mechanism 24 is operable in response to instructions from the CPU 20 to award a payoff to the player. The payoff may, for example, be in the form of a number of credits. The number of credits are determined by one or more math tables stored in the system memory 22.

The wagering game is described below wherein the basic game is a multi-line, multi-coin video reel slot game. It should, however, be understood that the basic game may be any type of wagering game, including but not limited to video or mechanical reel slots (one or more pay lines), poker, keno, bingo, blackjack, or roulette.

Referring back to FIG. 1, to play a basic game in the form of reel slots, a player may select a number of pay lines using the “Select Lines” button, place a wager on each line using the “Bet Per Line” button, and start the reels 26 in motion using the “Spin Reels” button. Alternatively, the player may select all lines, play the maximum bet or, each line, and start the reels 26 in motion using the “Max Bet Spin” button. In response to pressing the “Max Bet Spin” button, or a “Spin Reels” button for a wager less than the maximum, the CPU spins and randomly stops the plurality of symbol-bearing reels 26 to place symbols on the reels 26 in visual association with a number of pay lines 28. Other mechanisms, such as a handle, may be used to set the reels 26 in motion. The number of pay lines 28 may, for example, be nine, fifteen, or twenty, but more or less pay lines may be provided is desired. As noted above, the primary display 12 on which the reels are implemented may be mechanical or video. If the primary display 12 is video, the reels are simulated with moving graphics. If, however, the primary display 12 is mechanical, the reels are physical and rotatably driven by stepper motors.

The CPU 20 may use a random number generator to select a game outcome (e.g., “basic” game outcome) corresponding to a particular Set Of reel “stop positions.” The CPU 20 then causes each of the reels 26 to stop at the appropriate stop position. Symbols are displayed on the reels 26 to graphically illustrate the reel stop positions and indicate whether the stop positions of the reels 26 represent a winning game outcome. Winning basic game outcomes (e.g., symbol combinations resulting in payment of coins or credits) are identifiable to the player by a pay table. The pay table may be affixed to the machine 10 and or displayed by the primary display 12 in response to a command by the player (e.g. by pressing the “Pay Table” button). A winning basic game outcome occurs when the symbols appearing on the reels 26 along an active pay line 28 correspond to one of the winning combinations on the pay table. A winning combination could, for example, be three or more matching symbols along an active pay line 28, where the award is greater as the number of matching symbols along the active pay line 28 increases. If the displayed symbols stop in a winning combination, the game credits the player an amount corresponding to the award in the pay table for that combination multiplied by the number of wagered credits. The player may collect the amount of accumulated credits by pressing the “Collect” button.

Included among the plurality of basic game outcomes are one or more start-bonus outcomes for triggering play of bonus games. A start-bonus outcome may be defined in any number of ways. For example, a start-bonus outcome may occur when a special start-bonus symbol or a special combination of symbols appears on one or more of the reels 26. A start-bonus outcome may require the combination of symbols to appear along an active pay line 28, or may alternatively require that the combination of symbols appear anywhere on the display regardless of whether the symbols are along an active pay line 28. The appearance of a start-bonus outcome causes the CPU to shift operation from the basic slot game to the bonus game associated with that start-bonus outcome.

Embodiments of the invention are directed to the implementation of a slot wagering game have a “Men In Black”™ theme entitled “Riches of the Universe” with several available bonuses. Three of the bonus games, the “Alien Bonus,” the “Wild Bonus” and the “Locker Bonus” are described below.

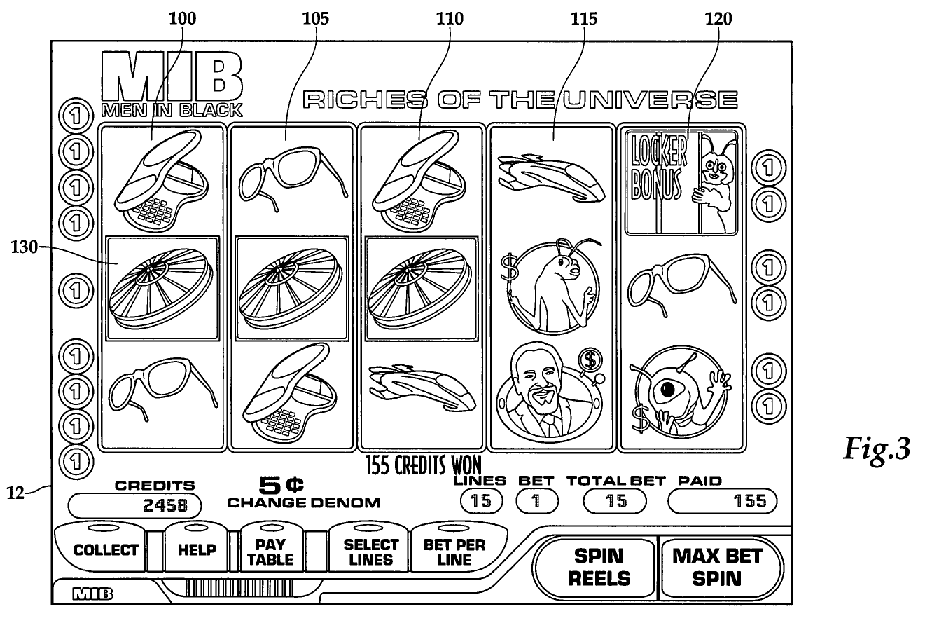

FIG. 3 illustrates a video slot game having five reels 100, 105, 110, 115, and 120. In other embodiments, more or fewer than five reels may be utilized. As shown, three visible symbols are displayed on each of the reels. In other embodiments, more or fewer than three visible symbols may be displayed on each of the reels. The player may be awarded with a payout when a winning combination of, e.g., three of the same symbol are located on an active winning pay line after the reels in the slot wagering game come to rest after a spin. The player may also be awarded with a bonus game, such as the “Alien Bonus” game.

The “Alien Bonus” game may be triggered by a combination of at least three spaceship symbols 130 on an active pay line. In other embodiments, the “Alien Bonus” game is only available when the player has wagered on the maximum number of pay lines. In additional embodiments, more or fewer than three spaceship symbols 130 on an active pay line trigger the “Alien Bonus” game. Additional embodiments trigger the “Alien Bonus” game when at least three of the spaceship symbols 130 are displayed anywhere on the five reels 100, 105, 110, 115, and 120.

As shown in FIG. 3, the player has achieved a combination of three spaceship symbols 130 as the middle visible symbols on the first, second, and third reels 100, 105, and 110. Accordingly, the “Alien Bonus” game is triggered in the event that these spaceship symbols 130 are located on an active pay line.

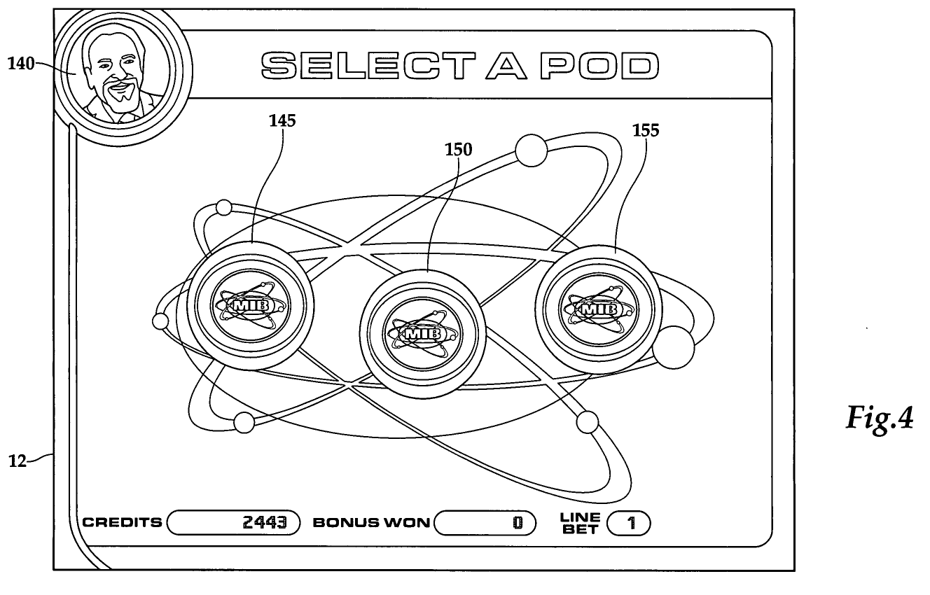

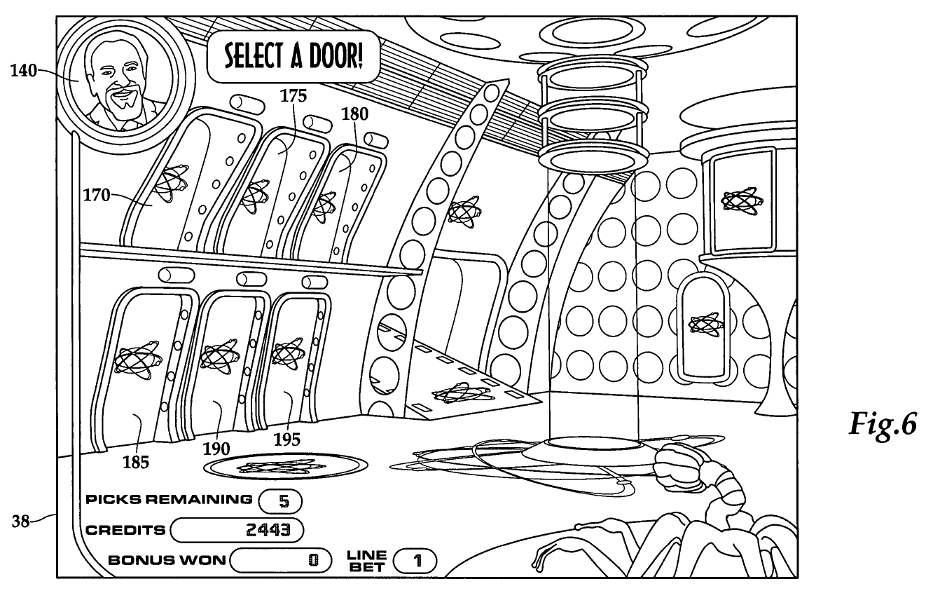

Next, the primary display 12 displays the screen shown in FIG. 4. As illustrated, an “Agent Z” symbol 140 appears in the upper left-hand corner of the screen. Three pod symbols 145, 150, and 155 are also displayed in, e.g., the center of the screen. The player is then instructed to select one of the pods 145, 150, and 155 to reveal a number of picks of selectable doors, as discussed below with respect to FIGS. 6-8. The “Agent Z” symbol 140 may, e.g., audibly instruct the player to select one of the pods 145, 150, and 155.

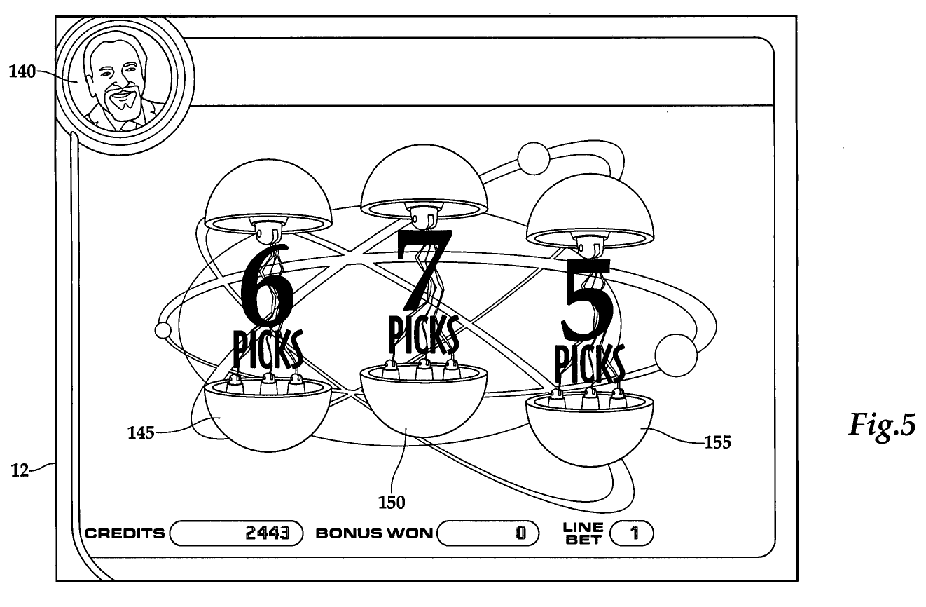

After the player has selected one of the pod symbols 145, 150, and 155, the number of picks masked by each of the pod symbols 145, 150, and 155 are displayed to the player and the player is awarded the number of free picks masked by the selected pod. For example, the player may select the third pod symbol 155, in which case the player would be awarded 5 picks, as illustrated in FIG. 5. As shown, the picks masked by the other two pod symbols 145 and 150 are displayed. The picks masked by the other two pod symbols 145 and 150 may be shaded with a grey color so that the 5 picks award of the third pod symbol 155 is shown more prominently.

Next, in FIG. 6, the player is shown a new screen for the “Alien Bonus” game. This new screen may, e.g., be displayed on the secondary display 38 of the top box 13 of the gaming terminal 10 of FIG. 1. As illustrated, the player is shown a plurality of selectable doors 170, 175, 180, 185, 190, and 195. In other embodiments, more or fewer than six selectable doors may be utilized. At least one captured alien hides behind each door. The “Agent Z” symbol 140 may indicate to the player that the player needs to manage the exportation of the captured aliens back to their home planets. There are three different types of aliens, each of which has a different value. For example, one type of alien may be worth more credits than a second type of alien. As a simplified example, a blue alien may be worth 5 credits per alien, a yellow alien may be worth 7 credits per alien, and a red alien may be worth 10 credits per alien. In other embodiments, more or fewer than three types of aliens may be utilized.

Four of the six displayed doors each hide or are associated with or assigned a number of one of the types of aliens. Two of the doors hide or are associated with or assigned a variety of each of the three types of aliens. In other embodiments, more or fewer than four of the doors may hide or be associated with or assigned one of the types of aliens, and more or fewer than two of the doors may hide or be associated with or assigned a variety of each of the three aliens. Also, in other embodiments, some of the doors may hide two of the three types of aliens. The number of aliens hiding behind, or assigned or associated with any of the doors in unknown to the player before a respective door is selected. The types of aliens are also unknown to the player before the respective door is selected.

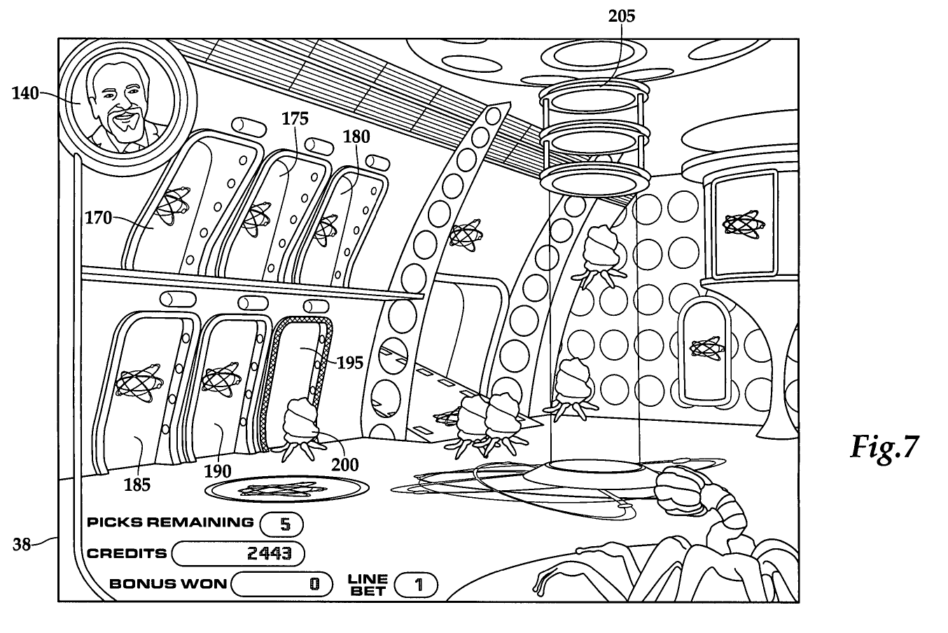

After the player has selected the first door with one of the picks, the door opens and a number of aliens come rushing out, as shown in FIG. 7 where the player has selected door 195. After door 195 is selected, a plurality of a first type of alien 200 come rushing out of the door 195 and over to a tube 205, where they are transported to their home planet or spaceship. For example, 11 of the first type of aliens 200 come rushing out, each of which are worth, e.g., 5 credits apiece, providing the player a total of 55 credits.

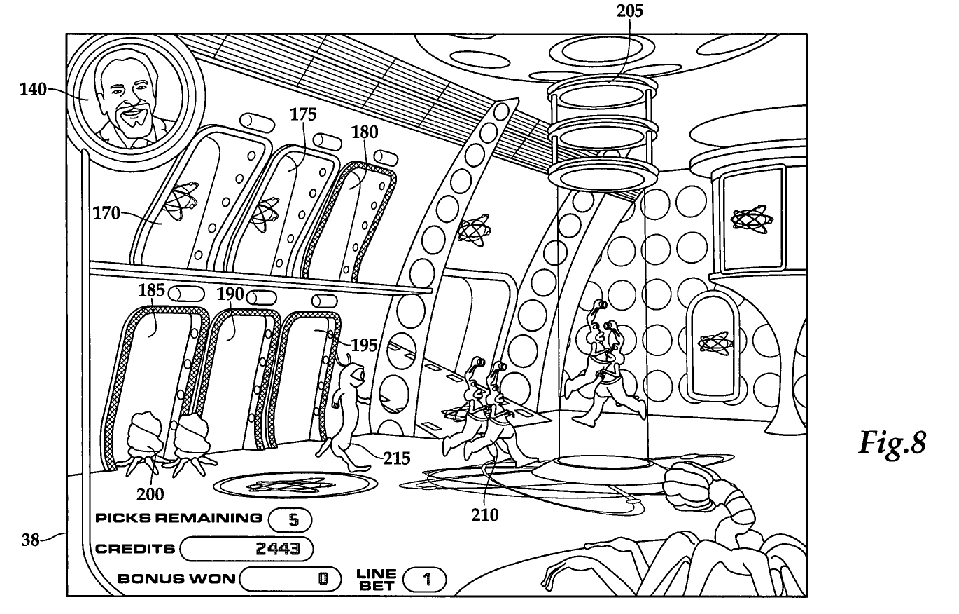

After the first type of aliens 200 that were hidden behind the selected door 195 have all rushed out and been sucked up the tube 205, the player continues to make additional selections of the doors until all of the player's picks have been used. FIG. 8 illustrates the game screen shown on the secondary display 38 of the top box 13 after the player has used the player's fourth pick to select door 185. As shown, several different types of aliens were hidden behind door 185. Several of a second type of alien 210 initially rush out, followed by several of a third type of alien 215 and of the first type of alien 200. The first type of alien 200 may be worth 5 credits apiece, as discussed above, the second type of alien 210 may be worth 7 credits apiece, and the third type of alien may be worth 10 credits apiece. The player is rewarded accordingly for all of the aliens rushing out from behind the door 185. In some embodiments, additional aliens sometimes rush out from behind doors that were selected with previous picks, providing additional excitement for the player and making the player feel as though the bonus game is being extended. For example, when the player selected door 185 with the fourth pick, some aliens may rush out from door 195, which the player had selected with the first pick. A different number of the aliens 200, 210, and 215 may be hidden behind each of the doors and the player has no way of knowing how many aliens, or what kinds of aliens are hidden behind a particular door until the door is selected.

After all of the player's picks have been used, the player is awarded with the accumulated bonus points for all of the aliens that were behind doors that the player selected. Next, bonus game play proceeds to an “Agent Bonus” game where the player has the opportunity to earn additional credits or the opportunity to replay the “Alien Bonus” game with the same number of picks as where previously awarded when the player selected one of the pods, as shown in FIGS. 4 and 5. If the player is award the replay, the “Agent Bonus” game is disabled the second time the “Alien Bonus” game is played.

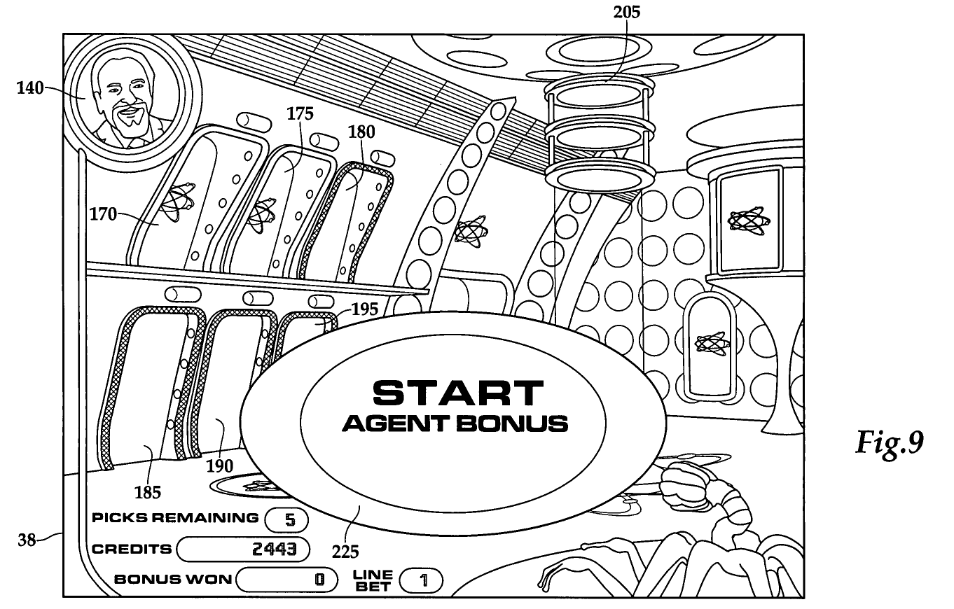

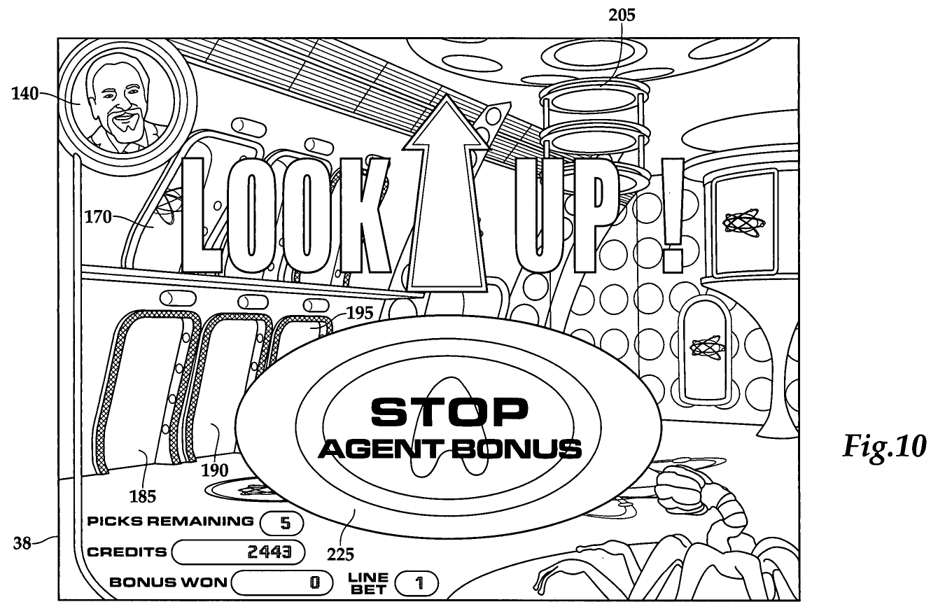

During the “Agent Bonus” game, an egg 225 is displayed in the center of the screen, as shown in FIG. 9, and begins flashing various awards. The player may stop the flashing by pressing a button. When the flashing stops, the player is awarded the displayed award. The flashing is at a high rate so that the player's input still yields a random outcome. As shown in FIG. 10, when the player depresses the button, the egg 225 stops flashing and the player is instructed to look up a game screen (not shown) which indicates the award the player has won. In this case, the player is awarded 100 additional credits for the “Agent Bonus” game.

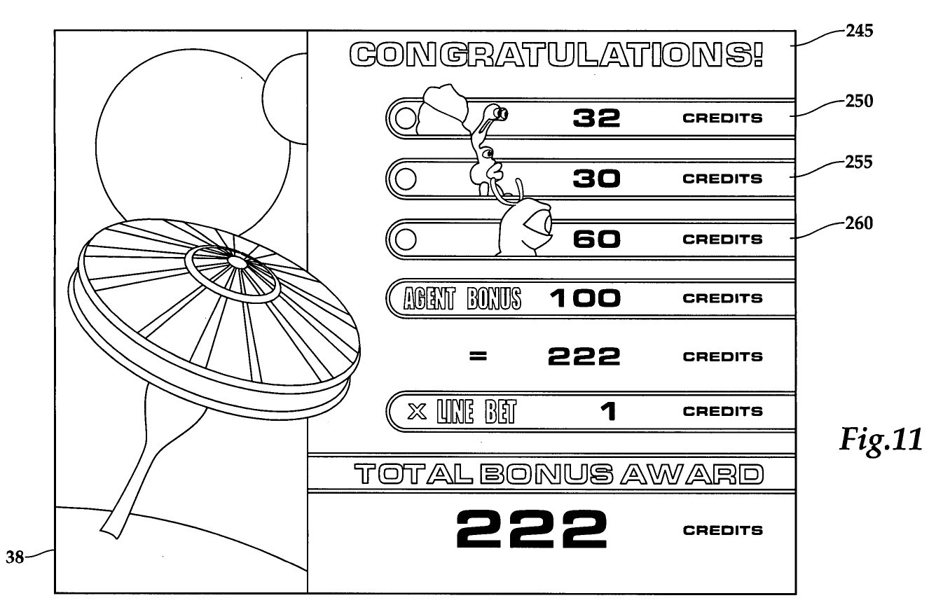

A scorecard 245 is then displayed, as shown in FIG. 11. The scorecard 245 has various meters 250, 255, and 260 for indicating the number of the first type of alien 200, the second type of alien 210, and the third type of alien 215 the player was awarded when selecting among the selectable doors 170, 175, 180, 185, 190, and 195. The scorecard 245 also indicates the credits awarded during the “Agent Bonus” game, the amount of the player's wager, and the total bonus awarded. The wagering game then returns to basic game play.

Another type of bonus game triggered through basic game play is the “Locker Bonus” game. The “Locker Bonus” game may be triggered, e.g., by a combination of at least three scattered “Locker Bonus” symbols across reels of the slot wagering game. In other words, if at least three “Locker Bonus” symbols are displayed anywhere on the reels the player will be awarded the “Locker Bonus” game. In other embodiments, the “Locker Bonus” game is only available when the player has wagered on the maximum number of pay lines. In additional embodiments, more or fewer than three scattered “Locker Bonus” symbols trigger the “Locker Bonus” game. In other embodiments, the “Locker Bonus” game is triggered only when at least three of the “Locker Bonus” symbols are displayed on an active pay line. When the “Locker Bonus” game is triggered, the player transitions to a pick screen. On the screen resides a dog symbol that is displayed and instructs the player as to how to play the “Locker Bonus” game. A scoreboard is also displayed that contains the following information: the number of credits the player currently has, the number of credits earned in the bonus, the number of free spins earned, and the multiplier award for the winning spins. In the center of the screen, a plurality of alien symbols, such as 13, are displayed as standing before the player, grabbing the player's attention in hopes that the player will select them.

The player may select from the alien symbols to receive awards. In some embodiments, the player may select a predetermined number of the alien symbols such as, e.g., 7 of the alien symbols. In other embodiments, the player continues selecting alien symbols until an alien symbol is selected that reveals a bonus game-ending award. When player selects the alien symbols, three different awards may be given—a number of free spins (masked by, e.g., 7 of the 13 of the alien symbols), credit amounts (masked by, e.g., 4 of the 13 alien symbols), or multiplier amounts (masked by, e.g., 2 of the alien symbols). The awards are tallied in the meters at the top of the pick screen in the scoreboard.

If an alien symbol reveals a credit amount when selected, that award appears in the vicinity of the alien, and then is tallied on the “scoreboard”. If an alien reveals a multiplier when selected, that award appears in the vicinity of the alien, and then is tallied on the “scoreboard” as well. The multiplier, though, is applied during a free spin portion of the game.

When the player selects an alien that contains a number of free spins, the picking portion of the bonus game may end, and the screen then transitions to a free spin screen. The player is initially awarded a 1× multiplier to start for the free spins. Any multipliers accumulated during the picking portion of the game are then applied at this point.

The free spin screen contains the following information: the number of spins remaining, the multiplier award for all winning spins, the player's credit meter, the total bet the player made, and a bonus meter displaying the player's total award for the bonus with their current bonus winnings already present. During free spins the line bet and the bet per line remain the same as they were during the spin that triggered the bonus.

On the free spin screen, the player is prompted to press a button to begin the free spin process. When the button is pressed, the player will notice that the reels do not spin like traditional reels. Instead, the reel symbols themselves swirl into various logos and then unswirl back into new reel symbols. Line pays are then awarded and multiplied out accordingly. The bonus round ends when the player's free spins are exhausted.

Also included in the free spin portion of the bonus is a single symbol scatter pay located on, e.g., the third reel. Whenever a locker alien symbol appears anywhere on the third reel, a scatter pay credit amount is awarded to the player at the end of the free spin bonus. During the bonus round, players can typically expect to see about two of these events occur. Each time the player achieves the locker alien symbol on the third reel, a locker alien symbol is displayed above the reels. Also, whenever the locker alien symbol is displayed on the third reel, the locker alien symbol moves as an animation to provide additional excitement to the player.

After the player has exhausted all of the accumulated free spins, the accumulated locker alien symbols shown above the reels are each converted into additional credit amounts. Basic game play subsequently resumes.

Another available bonus game is a wild bonus game. The wild bonus game may be triggered when a wild symbol is displayed that forms part of a winning symbol combination. An animation may then be displayed to the player during which the wild symbol moves. First, if the wild symbol is located at, e.g., the middle symbol position on one of the reels, the wild symbol may drop down to the bottom symbol positions on that reel. Next, a large alien symbol may be displayed that encompass the entire reel. Finally the large alien symbol becomes wild for all visible symbol positions on that reel. The large alien symbol is known as an “expanding wild” symbol because it causes multiple symbols to become wild. After the large alien symbol has become wild, the player may achieve winning combinations on multiple pay lines that would not have been possible if the large alien symbol had not become wild across multiple symbol positions.

Each of these embodiments and obvious variations thereof is contemplated as falling within the spirit and scope of the claimed invention, which is set forth in the following claims.

What is claimed is:

1. A gaming machine for playing a wagering game, comprising:
a wager-input device;
at least one display for displaying a plurality of player-selectable elements that mask corresponding ones of a plurality of awards, the plurality of awards including multiple types of the plurality of awards, each one of the plurality of awards of the same type having a predetermined value that is different from a value of a different one of the types of the plurality of awards, at least one player-selectable element masking at least two different types of awards; and
an input device for receiving player-inputs that select at least two of the plurality of player-selectable elements, wherein a number and a type of the masked awards corresponding with the selected player-selectable elements are revealed to the player in response to receiving the player inputs.

2. The gaming machine of claim 1, wherein at least one of the player-selectable elements masks a plurality of only a first type of the awards.

3. The gaming machine of claim 1, wherein the input device allows the player to select a selected number of the player selectable elements, the selected number of the player-selectable elements being determined based on a selection of one of a second set of player-selectable elements.

4. The gaming machine of claim 1, wherein in response to the player having selected the plurality of player-selectable elements, the player is displayed a bonus player-selectable element corresponding to a bonus award selected from the group consisting of a payoff and a replay of a selection of the plurality of the player-selectable elements.

5. The gaming machine of claim 1, wherein in response to the player selecting a first element of the player-selectable elements and receiving the masked awards corresponding to the first element, and subsequently selecting a second element of the player-selectable elements and receiving the masked awards corresponding the second element, the player receives additional bonus masked awards corresponding to the first element.

6. The gaming machine of claim 1, wherein the player-selectable elements are displayed during a bonus game triggered via an occurrence of a bonus game triggering event during a basic game of the wagering game.

7. The gaming machine of claim 6, wherein the basic game is a slot wagering game having moveable reels.

8. The gaming machine of claim 1, wherein each of the plurality of player-selectable elements masks at least two different types of awards.

9. A method of conducting a wagering game on a gaming machine, the method comprising:
displaying a plurality of player-selectable elements that mask corresponding ones of a plurality of awards, the plurality of awards including multiple types of the plurality of awards, each one of the plurality of awards of the same type having a predetermined value that is different from a value of a different one of the types of the plurality of awards;
receiving player-inputs associated with the selection of the plurality of player-selectable elements;
in response to the selection of a first element of the plurality of the plurality of player-selectable elements, revealing and awarding a first group of the masked awards corresponding to the first element of the plurality of the plurality of player-selectable elements; and
in response to the selection of a second element of the plurality of the plurality of player-selectable elements, revealing and awarding a second group of the masked awards corresponding to the second element of the plurality of the plurality of player-selectable elements, the first and second groups including awards of different types.

10. The method of claim 9, wherein the displaying includes displaying at least one of the player-selectable elements masking a plurality of only a first type of the awards.

11. The method of claim 9, wherein a first type of award has a value of 5 credits and a second type of award has a value of 10 credits.

12. The method of claim 9, wherein a number of the selections is randomly determined.

13. The method of claim 9, wherein the displaying the plurality of player-selectable elements occurs in a bonus game for the wagering game, and further including triggering bonus game play of the bonus game via an occurrence of a bonus-game-triggering event during a basic game of the wagering game.

14. A computer readable storage medium encoded with instructions for directing a gaming device to perform the method of claim 9.

15. A gaming system for playing a wagering game, comprising:
at least one display; and
a controller coupled to the display and programmed to
display a plurality of player-selectable elements that mask corresponding ones of a plurality of awards, the plurality of awards including multiple types of the plurality of awards, each one of the plurality of awards of the same type having a predetermined value that is different from a value of a different one of the types of the plurality of awards;
receive player-inputs associated with the selection of the plurality of player-selectable elements;
reveal and award a first group of the masked awards corresponding to the first element of the plurality of the plurality of player-selectable elements in response to the selection of a first element of the plurality of the plurality of player-selectable elements; and
reveal and award a second group of the masked awards corresponding to the second element of the plurality of the plurality of player-selectable elements in response to the selection of a second element of the plurality of the plurality of player-selectable elements, the first and second groups including awards of different types.

16. The gaming system of claim 15, wherein the display and the controller are both located within a gaming terminal.

17. The gaming system of claim 15, wherein the display is located within a gaming terminal and the controller is located outside of the gaming terminal.

18. The gaming system of claim 15, wherein at least one of the player-selectable elements masks a plurality of only a first type of the awards, and at least another one of the player-selectable elements masking at least two of the types of awards.

19. The gaming system of claim 15, wherein the input device allows the player to select a selected number of the player selectable elements, the selected number of the player-selectable elements being determined based on a selection of one of a second set of player-selectable elements.

20. The gaming system of claim 15, wherein in response to the player having selected the plurality of player-selectable elements, the player is displayed a bonus player-selectable element corresponding to a bonus award selected from the group consisting of a payoff and a replay of a selection of the plurality of the player-selectable elements.
